(19) United States
(12) Patent Application Publication
(10) Pub. No.: US 2001/0042401 A1
(43) Pub. Date: Nov. 22, 2001

(54) Device for the measurement of speeds and torques and for the simulatio of driving conditions on a driven shaft for a motor vehicle wheel

(76) Inventors: Richard Norres, Gelsenkirchen (DE); Albert Norres, Gelsenkirchen (DE)

Correspondence Address: Edward G. Greive, Renner, Kenner, Greive, Bobak, Taylor & Weber, Fourth Floor, First National Tower, Akron, OH, 44308-1456, US

(21) Appl. No.: 09/774,137

(22) Filed: Jan. 30, 2001

(30) Foreign Application Priority Data
Feb. 4, 2000 (DE) 100 05 043.3-52

(51) Int. Cl. G01M 17/02

(52) U.S. Cl. 73/146

(57) ABSTRACT

The invention concerns a device (1) for the measurement of speeds and torques and for the simulation of driving conditions on a driven shaft (3) for a motor vehicle with a driveshaft (4) and at least one electrical machine (31), having a rotor (5) and a stator (6), whose rotor shaft (7) is mechanically connected with the driveshaft (4) and which is mechanically coupled via a detachable connection with the driven shaft (3) for the motor vehicle wheel so that they rotate together.

The invention is based on the task of making a device of this type with which, in addition to the speed and torque measurements, the flow behavior of a motor vehicle and the sound intensity generation of this motor vehicle can be simulated in a wind tunnel relative to a motor vehicle provided with typical tires.

This task is solved according to the invention in that the driveshaft (4) is surrounded by a stator rim (8) located concentrically to it in a way known in and of itself, the stator (6) is attached to the stator rim (8) in a way known in and of itself, and the device (1) has an external circumference with essentially the rotationally symmetrical form of a motor vehicle wheel and is tailored to the wheel housing (9) of the motor vehicle (A).

### DESCRIPTION

The invention concerns a device for the measurement of speeds and torques and for the simulation of driving conditions on a driven shaft for a motor vehicle wheel, having a driveshaft and at least one electrical machine, having a rotor and a stator, whose rotor shaft is mechanically attached to the driveshaft, and which is mechanically coupled via a detachable connection with the driven shaft for the motor vehicle wheel so that they rotate together.

The detection of stationary and dynamic operating states when a motor vehicle is at a standstill is increasingly important for the development and evaluation of motor vehicles, because many measurements necessary for the detection of these operating states can only be performed at increased expense while the vehicle is traveling. In order to simulate the detection of such dynamic operating states while the vehicle is at a standstill, stresses occurring on the driven shafts of the motor vehicle during travel are produced by controllable torque generating devices attached to the shafts. This type of torque generating device can be designed as an electrical machine, particularly as a typical electrical DC machine, by means of which the desired stresses can be applied via a suitable electrical control.

This type of device is known from DE 38 01 647 C2. According to this patent specification, a device for testing an all wheel drive with two differential gears is disclosed, with four DC shunt machines attached to the axle shafts of the all wheel unit driven by an internal combustion engine. The individual driven shafts can, in order to be stressed, be impinged upon by a torque which is applied with the aid of a DC machine. With such a device, stationary and dynamic operating states can be detected in a motor vehicle at a standstill.

However, this device has significant disadvantages when used in a wind tunnel. Because braking units with electrical DC machines are coupled to the four driven shafts instead of wheels, the flow behavior of the air in the region of the DC machines differs from the flow behavior of the air on typical motor vehicle wheels when this device is transferred from the all wheel unit to a motor vehicle and operated in a wind tunnel. This has effects on the flow resistance of the motor vehicle as a whole and on the noise generated by, for example, vortex formation produced by the flowing air in the region of the DC machines.

Particularly for noise measurements in the motor vehicle, e.g. in its passenger space, such changes in the flow behavior have effects on the intensity of the noise and the aerodynamic drag factor of the vehicle.

The testing of material stresses of, for example, a strongly warped body of a four-wheel drive (with the 4 measurement simulation wheels on planes which are at varying heights and inclined to one another and which can even be altered during a test) is possible with the previously mentioned device at extreme temperatures and with the vibrations and noises which arise from motor operation and/or with the effect of outside forces, e.g. the effects of braking force or potholes.

Proceeding from this prior art, the invention is based on the task of making a device of the type described initially with which, in addition to the measurement of speed and torques, the flow behavior of the vehicle and the sound intensity generated in this vehicle in a wind tunnel, as well as the previously mentioned vibration analyses, noises generated, and material stresses under extreme conditions, can be simulated relative to a vehicle provided with typical wheels.

According to a first alternative, this task is solved according to the invention in connection with the initially mentioned generic concept in that

the driveshaft is surrounded by a stator rim positioned concentrically to it in a way that is known in and of itself,

the stator is attached to the stator rim in a way that is known in and of itself, and

the device has an external circumference with essentially the rotationally symmetric form of a motor vehicle wheel and is tailored to the wheel housing of the motor vehicle. Due to this implementation, the behavior of the flowing air in the region of the device corresponds to the behavior of the flowing air in the region of a typical motor vehicle wheel. A motor vehicle located in a wind tunnel and provided with the device according to the invention has essentially the same flow resistance and generates the same noise as a motor vehicle with typical motor vehicle wheels.

According to an advantageous further development of the invention, the rotor is located concentrically to the driveshaft, which simultaneously forms the rotor shaft, while the stator extends around the stator rim along its circularly cylindrical inner side. A particularly simple design of the device is hereby made which can be realized on the basis of a typical electrical machine, without costly mechanical systems.

According to a second alternative, the task is solved according to the invention in connection with the initially mentioned generic concept in that

the driveshaft is surrounded by a stator rim positioned concentrically to it,

the stator is attached to the stator rim, and

the device has an external circumference with essentially the rotationally symmetric form of a motor vehicle wheel and is tailored to the wheel housing of the motor vehicle. Through this implementation, as in the implementation according to the first alternative, the flow behavior and the sound intensity generation of a motor vehicle provided with the device according to the invention will correspond to those of a motor vehicle provided with typical tires.

According to an advantageous further development of the invention, the rotor is positioned eccentrically to the driveshaft and its rotor shaft is rotatable on the stator rim and is coupled via a gearing with the driveshaft. It is therefore possible through suitable design of the gearing to set the speed of the rotor shaft at a speed range which is advantageous for the electrical machine.

Only one single electrical machine can be implemented in the device. According to a further, particularly advantageous development of the invention, the device nonetheless has several electrical machines, each with a rotor and a stator which are positioned on the inner side of the stator rim at the same distance from one another and from the geometrical rotational axis of the stator rim. It is thereby possible to distribute torques to be accepted by the device symmetrically and with equal amounts of torque to several electrical machines. This is particularly advantageous in the simulation of large stresses of the motor vehicle, e.g. in the simulation of full braking, because the amounts of heat thus resulting can be transferred to the environment over a large total area.

The rotor shaft can be connected with the driveshaft via a driving synchronous belt or a drive chain. According to an advantageous development of the invention, the gearing is formed by a planetary gearing whose sun wheel rotates with the driveshaft and whose planetary wheels, driven by the sun wheel, rotate with the rotor shaft of the respective electrical machine. A development of the gearing which is particularly simple to realize is hereby created.

The sun wheel and the planetary wheels can be formed by friction wheels which rub against one another. However, according to an advantageous development, the planetary gearing is formed by bevel gear wheels which engage with one another. This has the advantage that a connection of the sun wheel and the planetary wheels in which they rotate together is always guaranteed, while in contrast, for coupling via friction wheels, the danger exists that, after they are worn down due to use, there will be too much slip between the sun wheel and the planetary wheels.

According to a further, particularly advantageous development of the two solution alternatives of the invention, the electrical machine is a DC machine which is known in and of itself. DC machines are long-established and widely distributed in electrical engineering. A significant saving in cost in comparison to rarer electrical machines is linked with the selection of this type of standard machine. Furthermore, the control technology for DC machines is long-established and may be considered mature.

The device can be placed directly on the floor with the stator rim. According to a further, particularly advantageous development of the two solution alternatives of the invention, the device has a wheel rim on its external circumference which is provided with a tire known in and of itself. The shape of the device thereby practically corresponds with the external geometrical shape of a typical tire. Furthermore, the motor vehicle can now, like a motor vehicle provided with typical tires, be rolled and, for example, moved to another location and even driven with its own engine power, if a temporary connection between the driveshaft and the stator rim is made, without the danger of damage to the stator rim.

According to a further development of the first and second alternatives of the invention, the device has a mechanically, hydraulically, pneumatically, or electromagnetically driven pulse machine which works together with the bearing surface of the tire formed by the floor in such a way that the pulse machine supplies a controllable and adjustable pulse sequence to the bearing surface for the simulation of potholes. It is possible to simulate pavement irregularities with this type of pulse machine.

The invention will be described with the aid of two preferred embodiments with reference to the drawings. The drawings show:

FIG. 1 the side view of a motor vehicle with a first preferred embodiment of the device according to the invention in the wind tunnel,

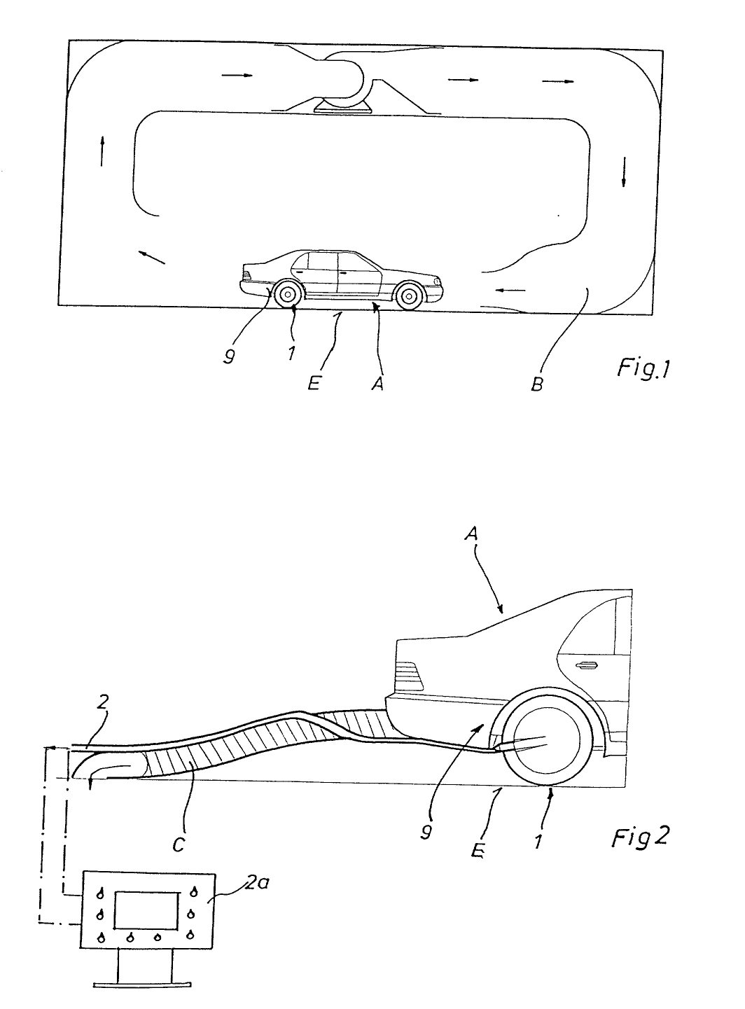

FIG. 2 an enlarged illustration of the rear of the vehicle with the first embodiment visible in FIG. 1,

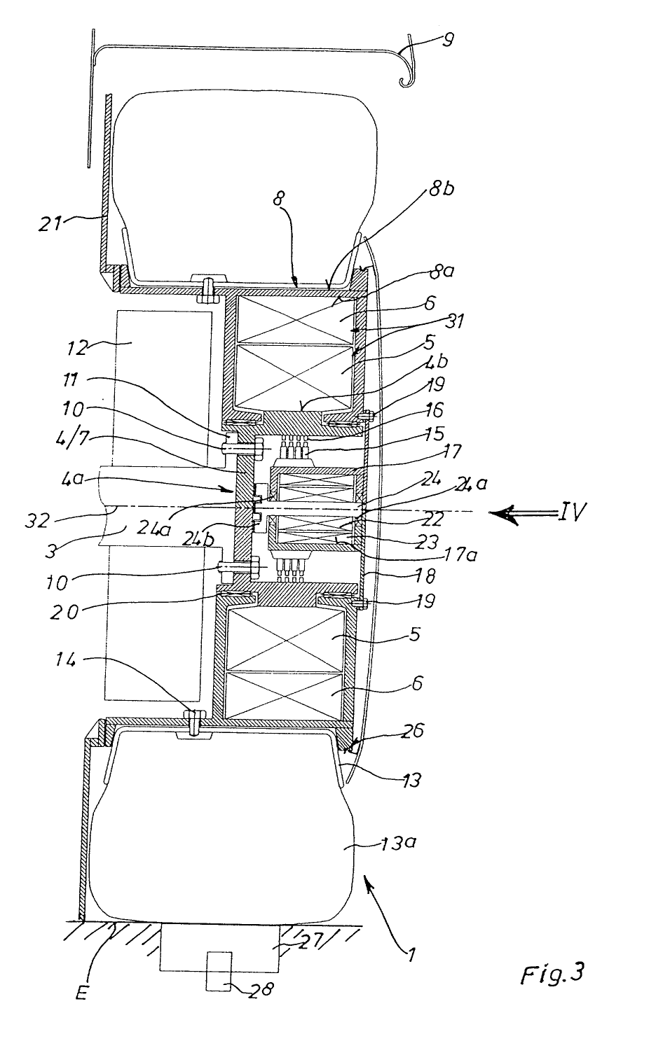

FIG. 3 the view of a diametrical section through the first embodiment of the invention,

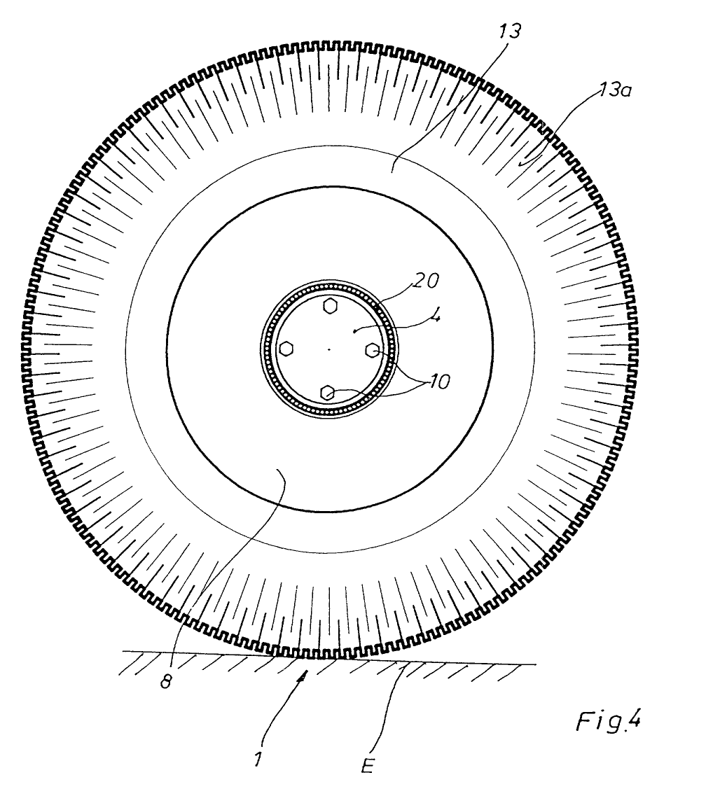

FIG. 4 the front view of the first embodiment, with the protective cap removed, in the direction of the arrow IV of FIG. 3,

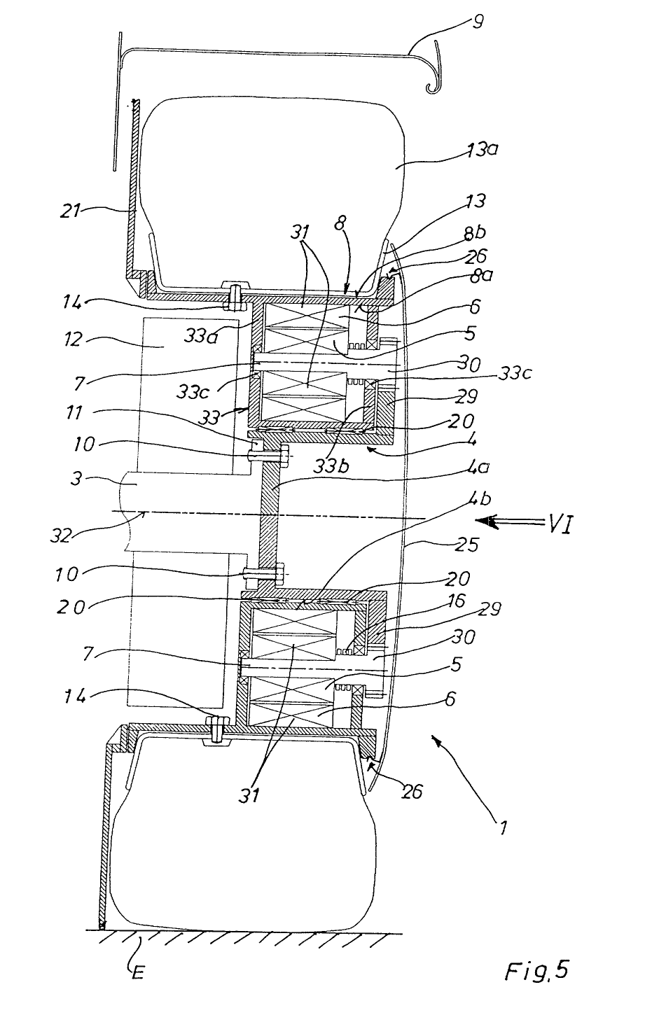

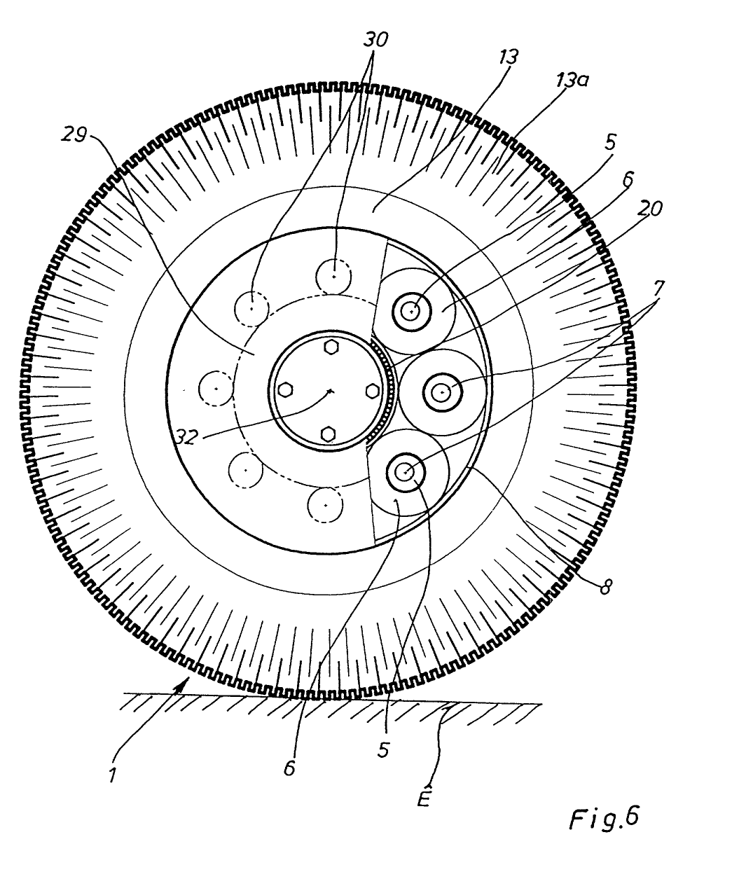

FIG. 5 the view of a diametrical section through the second embodiment of the invention, and

FIG. 6 a front view of this second embodiment, without the protective cap, in the direction of the arrow VI of FIG. 5.

The first embodiment of the invention is illustrated in FIGS. 1 to 4. For the measurement of stationary and dynamic operating states of a stationary motor vehicle A, this motor vehicle A is located in a wind tunnel B, with the air flowing through the wind tunnel B in the direction of the arrow. For the measurement of waste gasses and to prevent pollution of the air in the wind tunnel B, the waste gasses of the motor vehicle A are conducted out of the wind tunnel B through a hose C according to FIG. 2. The device 1 tailored to the wheel housing 9 of the motor vehicle A according to the first embodiment is placed on the floor E and connected according to FIG. 2 via electric lines 2 with a measurement and control device 2a. In order to prevent increased sound intensity, which could occur due to the turbulence produced by the electric lines 2, the electrical lines 2 are led, with the waste gas hose C, out of the flow area relevant for the measurement of sound intensity.

The device 1 according to the first embodiment has a pot-shaped driveshaft 4, in the shape of a hollow cylinder open on one side, whose closed floor 4a is attached by means of screws 10 to a flange 11 of a driven shaft 3 for a motor vehicle wheel. The driveshaft 4 is concentrically surrounded by a stator rim 8, in which it is rotatable via bearings 20. According to the first alternative of the invention, the driveshaft 4 simultaneously forms the rotor shaft 7 of the rotor 5 of an electrical DC machine, with the winding of the rotor 5 provided on the external circumference 4b of the driveshaft 4.

The stator 6 of the DC machine 31 is attached to the stator rim 8 and extends along the circularly cylindrical internal circumference area 8a of the stator rim 8, with the winding of the stator rim 8 electrically connected via the electrical lines 2 with the electrical control and adjustment unit 2a (cf. FIG. 2). In contrast, the winding of the rotor 5 is electrically connected in a way known in and of itself via sliding contacts 16 and via the electrical lines 2 with the electrical control and adjustment unit 2a, with the sliding contacts 16 located on the cylindrical inner surface of the pot-shaped driveshaft 4.

The sliding brushes 15 lying opposite to the sliding contacts 16 are located on the external circumference of a cylindrical body 17, which is inserted concentrically to the driveshaft 4 in its cavity and is held in place by a disk 18 which is attached via screws 19 to the stator rim 8.

The cylindrical body 17 has the shape of a hollow cylinder and forms the rim of a stator 23 for a second electrical machine, which serves as a speed measurement instrument for measuring the speed of the driven shaft 3. The stator 23 of the speed measurement instrument is attached in the shape of a ring to the circularly cylindrical internal peripheral surface 17a of the cylindrical body 17. In the circularly cylindrical body 17, the rotor shaft 24 is rotatable on both ends with the rotor 22 of the speed measurement instrument via bearings 24a which are located concentrically to the driveshaft 4 and the driven shaft 3 and which are coupled with the driveshaft 4 via a claw coupling 24b so that they rotate together.

A wheel rim 13, which is attached to the stator rim 8 via screws 14 so that they rotate together, is located concentrically to the stator rim 8 on its external circumference 8b. A pneumatic tire 13a is accommodated by the wheel rim 13, implemented as a flat base rim, as in a typical motor vehicle wheel. In order to prevent rotational movement of the stator rim 8 during the simulation of strong braking procedures, an anti-rotation element 21 can be attached to the stator rim when the device 1 according to the first embodiment is positioned at the measurement location. The anti-rotation element 21 extends in a radial direction over the periphery of the pneumatic tire 13a and can be supported on the floor E. It can also brace itself against the underside of the motor vehicle, thereby providing a very secure reinforcement, above all under extreme stresses.

In order to prevent air turbulence in the internal assembly of the device 1 according to the first embodiment, the device 1 is covered on the side lying opposite to the driven shaft 3 by a protective cap 25, which is removably attached via a clip attachment 26 to a peripheral groove provided on the stator rim 8.

As is visible from FIGS. 2 and 3, the device 1 according to the previously described first embodiment has an external circumference with essentially the rotationally symmetrical shape of a motor vehicle wheel and is tailored to the wheel housing 9 of the motor vehicle A.

Furthermore, for the simulation of potholes, a hydraulic pulse machine 27 is provided which is either—as depicted—located in the floor E or between the floor E and the bearing surface of the pneumatic tire 13a and, by means of a mechanically, hydraulically, pneumatically, or electromagnetically driven impact piston 28, delivers a sequence of pulses to the bearing surface of the pneumatic tire 13a in order to simulate potholes.

A second embodiment of the device 1 according to the invention is visible in FIG. 5. A driveshaft 4 in the shape of a pot-shaped hollow cylinder open on one side is attached via its closed floor 4a to the flange 11 of the driven shaft 3 of a motor vehicle via screws 10. The driveshaft 4 is concentrically surrounded on its external circumference by a stator rim 8 in which it is rotatable via bearings 20. Several electric DC machines 31, each with a rotor 5 and a stator 6, are located on the inner side 8a of the stator rim 8 at equal distances from one another and from the geometrical rotational axis 32 of the stator rim 8. Each DC machine 31 has a stator housing 33, formed by the stator rim 8, a housing floor 33a attached to the stator rim 8, and a housing cover 33b removably attached to the stator rim 8, in which the rotor shaft 7 of the rotor 5 is rotatable on both ends via bearings 33c.

The rotor shafts 7 of the rotors 5 of the respective DC machines 31 have, on their ends turned away from the driven shaft 3, planetary wheels in the shape of bevel gear wheels 30 which are driven by a sun wheel 29 (cf. FIG. 6), also implemented as a bevel gear wheel and attached to the driveshaft 4 so that they rotate together. A wheel rim 13 is positioned concentrically on the external circumference 8b of the stator rim 8 and connected via screws 14 with the stator rim 8 so that they rotate together. A pneumatic tire 13a is accepted by the wheel rim 13 implemented as a flat base rim. In order to prevent rotational movement of the stator rim 8 during the simulation of a strong braking procedure, an anti-rotation element 21, which projects radially outward over the pneumatic tire 13a, is attached to the stator rim 8 as soon as the device 1 has reached the measurement location.

Furthermore, as in the first embodiment according to FIGS. 3 and 4, the device 1 according to this second embodiment according to FIGS. 5 and 6 has its face lying opposite the driven shaft 3 covered by a protective cap 25, which is clipped in to a peripheral groove provided on the stator rim 8 by means of a clip attachment 26, in order to prevent air turbulence in the internal assembly of the device 1.

As can also be seen from FIG. 5, this second embodiment also has an external circumference with essentially the rotationally symmetrical form of a motor vehicle wheel and is tailored to the wheel housing 9 of the motor vehicle A.

In both embodiments, the wheel rim 13 is connected via screws 14 with the stator rim 8 so that they rotate together. However, when the pulse machine 27 is used to simulate potholes, it can be advantageous if the wheel rim 13 is not connected with the stator rim 8 so that they rotate together, but rather via a friction bearing so that the wheel rim is rotatable around the geometrical rotational axis 32.

For particularly high stresses, particularly for the simulation of braking procedures, the DC machines 31 can become overheated. In this case, it is practical to cool them via a coolant, such as, for example, liquid nitrogen. The carrying capacity of the DC machines 31 is thereby increased, with the liquid nitrogen supplied via a separate line to the device 1 together with the electrical lines 2 visible in FIG. 2. In a system cooled in this way, electrical machines whose electrical coils are made of superconducting material can also be used.

In both embodiments, the wheel rim 13 described as a one-piece flat base rim can also be implemented as a rim made of several parts. This makes the mounting of the pneumatic tire 13a on the wheel rim 13 easier. Furthermore, wheel rims 13 with different external diameters can be provided for mounting on the stator rim 8 in order to be able to adjust the device 1 to different tire sizes.

### LIST OF REFERENCE SYMBOLS

| | |
|---|---|
| Motor vehicle | A |
| Wind tunnel | B |
| Waste gas hose | C |
| Device | 1 |
| Electrical lines | 2 |
| Control device | 2a |
| Driven shaft | 3 |
| Drives shaft | 4 |
| Floor | 4a |
| External circumference | 4b |
| Rotor | 5 |
| Stator | 6 |
| Rotor shaft | 7 |
| Stator rim | 8 |
| Internal peripheral surface | 8a |
| External peripheral surface | 8b |
| Wheel housing | 9 |
| Screw | 10 |
| Flange | 11 |
| Brake | 12 |
| Wheel rim | 13 |
| Pneumatic tire | 13a |
| Screw | 14 |
| Sliding brushes | 15 |
| Sliding contacts | 16 |
| Cylindrical body | 17 |
| Internal peripheral surface | 17a |
| Disk | 18 |
| Screw | 19 |
| Bearing | 20 |
| Anti-rotation element | 21 |
| Rotor of the second electrical machine | 22 |
| Stator of the second electrical machine | 23 |
| Rotor shaft of the second electrical machine | 24 |
| Bearing for the rotor shaft 7 of the | 24a |
| second electrical machine 31 | |
| Claw coupling | 24b |
| Protective cap | 25 |
| Clip attachment | 26 |
| Pulse machine | 27 |
| Impact cylinder | 28 |
| Sun wheel | 29 |
| Planetary wheels | 30 |
| DC machines | 31 |
| Geometrical rotational axis | 32 |
| Stator housing | 33 |
| Housing floor | 33a |
| Housing cover | 33b |
| Bearing | 33c |

1. A device for the measurement of speeds and torques and for the simulation of driving conditions on a driven shaft for a motor vehicle, with a driveshaft and at least one electrical machine, having a rotor and a stator, whose rotor shaft is mechanically connected with the driveshaft and which is mechanically coupled via a detachable connection with the driven shaft for the motor vehicle wheel so that they rotate together,
characterized in that
the driveshaft (4) is surrounded in a way known in and of itself by a stator rim (8) located concentrically to it,
the stator (6) is attached to the stator rim (8) in a way known in and of itself, and
the device (1) has an external circumference with essentially the rotationally symmetrical form of a motor vehicle wheel and is tailored to the wheel housing (9) of the motor vehicle (A).

2. The device according to claim 1, characterized in that the rotor (5) is positioned concentrically to the driveshaft (4), which simultaneously forms the rotor shaft (7), while the stator extends around the stator rim (8) on its circularly cylindrical inner side (8a).

3. The device for the measurement of speeds and torques and for the simulation of driving conditions on a driven shaft for a motor vehicle, with a driveshaft and at least one electrical machine, having a rotor and a stator, whose rotor shaft is mechanically connected via a detachable connection with the driven shaft for the motor vehicle wheel so that they rotate together,
characterized in that
the driveshaft (4) is surrounded by a stator rim (8) located concentrically to it,
the stator (6) is attached to the stator rim (8), and
the device (1) has an external circumference with essentially the rotationally symmetrical form of a motor vehicle wheel and is tailored to the wheel housing (9) of the motor vehicle (A).

4. The device according to claim 3, characterized in that the rotor (5) is positioned eccentrically to the driveshaft (4) and its rotor shaft (7) is rotatable on the stator rim (8) and is coupled via a gearing with the driveshaft (4).

5. The device according to claim 4, characterized in that the device (1) has several electrical machines (31), each having a rotor (5) and a stator (6), which are located at equal distances from one another and from the geometrical rotational axis (32) of the stator rim (8) around its internal peripheral surface (8a).

6. The device according to claim 4 or 5, characterized in that the gearing is formed by a planetary gearing (29, 30) whose sun wheel (29) is connected with the driveshaft (4) so that they rotate together and whose planetary wheels (30), driven by the sun wheel (29), are connected with the rotor shaft (7) of the respective electrical machine (31) so that they rotate together.

7. The device according to claim 6, characterized in that the planetary wheels (29, 30) are formed by bevel gear wheels which engage with one another.

8. The device according to one of the claims 1 to 7, characterized in that the electrical machine (31) is a DC machine known in and of itself.

9. The device according to one of the claims 1 to 8, characterized in that the device (1) has a wheel rim (13) on its external circumference which is provided with a pneumatic tire (13a) known in and of itself.

10. The device according to claim 9, characterized in that it has a mechanically, hydraulically, pneumatically, or electromagnetically driven pulse machine (27) which works together with the bearing surface of the tire (13a) formed by the floor (E) in such a way that the pulse machine (27) transmits an adjustable and controllable pulse sequence to the bearing surface for the simulation of potholes.
